(19) United States
(12) Patent Application Publication
(10) Pub. No.: US 2023/0131765 A1
(43) Pub. Date: Apr. 27, 2023

(54) BACKUP AND RESTORE OF ARBITRARY DATA

(71) Applicant: SAP SE, Walldorf (DE)

(72) Inventor: Wolf Liebherr, Bruchsal (DE)

(21) Appl. No.: 17/452,177

(22) Filed: Oct. 25, 2021

(51) Int. Cl. G06F 11/14

(52) U.S. Cl. CPC G06F 11/1448

(57) ABSTRACT

A method, a system, and a computer program product for performing backup of data files in a parameter store. One or more data files in a plurality of data files are received for backup and storage in a parameter store. The data files are received from one or more file systems. One or more compressed data files corresponding to the received data files are generated. Using the compressed data files, one or more portions of the compressed data files are generated. The portions of the compressed data files are encoded by assigning a predetermined file name to each portion of the compressed data files. Each assigned predetermined file name has at least one common sequence of characters identifying the received data files. The encoded portions of the compressed data files are stored in the parameter store.

### TECHNICAL FIELD

This disclosure relates generally to data processing and, in particular, to backing up and restoring arbitrary data in object/key-value storage systems.

### BACKGROUND

File systems generate vast amount of data that require storage and backup to ensure that data is not lost and may be recovered. Various backup and data protection mechanisms and systems exist. Such mechanism/systems receive data intended for backup and store at a primary backup location. Periodically, a secondary or a remote backup location may be setup in addition a primary backup location to ensure that data is always available in the event one of the backup locations is no longer available. Existing backup system store all data received for backup, but do not allow backup of specific data files that may require protection.

### SUMMARY

In some implementations, the current subject matter relates to a computer implemented for performing backup of data in a parameter store. The method may include receiving one or more data files in a plurality of data files for backup and storage in a parameter store. The plurality of data files may be received from one or more file systems. The method may further include generating one or more compressed data files corresponding to the received data files, generating, using the compressed data files, one or more portions of the compressed data files, and encoding the portions of the compressed data files. The encoding may include assigning a predetermined file name to each portion in the portions of the compressed data files. Each assigned predetermined file name may have at least one common sequence of characters identifying the received data files. The method may also include storing the encoded portions of the compressed data files in the parameter store.

In some implementations, the current subject matter may include one or more of the following optional features. The method may also include generating a header file corresponding to the encoded portions of the compressed data files. The header file may include information identifying each of the encoded portions of the compressed data files. The header file may be stored in the parameter store. The method may also include receiving a request to restore from the parameter store the data files corresponding to the encoded portions of the compressed data file, identifying the header file corresponding to the encoded portions of the compressed data file, retrieving, using the identified header file, the encoded portions of the compressed data file from the parameter store, and restoring, using the retrieved encoded portions of the compressed data file, the data file.

In some implementations, the header file may be encoded. Further, each assigned predetermined file name may include a hash of at least a portion of the data file. At least one common sequence of characters in the assigned name may include identification of the file systems associated with the received data files.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for storing one or more data files in one or more parameter stores, according to some implementations of the current subject matter;

FIG. 2 illustrates an exemplary data file backup system, according to some implementations of the current subject matter;

FIG. 3 illustrates an exemplary process for performing a backup of the data file, according to some implementations of the current subject matter;

FIG. 4 illustrates an exemplary system, according to some implementations of the current subject matter; and

FIG. 5 illustrates an exemplary method, according to some implementations of the current subject matter.

### DETAILED DESCRIPTION

To address the deficiencies of currently available solutions, one or more implementations of the current subject matter provide for an ability to back up and restore arbitrary data in object/key-value storage systems.

In some implementations, the current subject matter may be configured to provide a parameter store and/or any other storage location that may be configured to store one or more files, data, metadata, application data, configuration data, settings data, etc. (hereinafter, “data files”). For example, the data files may be used for recovery and/or restore of one or more computing systems. The parameter store may be located in and/or accessed from a public and/or a private cloud computing environment. It may be configured to serve as a backup and/or restore location for the data files stored therein.

The parameter store may be used, for example, in situations, where a “full-blown” implementation of a data protection solution (e.g., backup and restore software, hardware, etc.) may be prohibitive, either from a cost, complexity, and/or operational perspectives. Conventional systems, which may include hyperscalers (e.g., public cloud computing systems) may include so-called secret or parameter stores, which may be intended to hold crucial runtime information (e.g., passwords, private keys, etc.). One or more application programming interfaces (APIs) and/or services may be designed in way that such sensitive information can be securely exposed to compute instances running within the respective computing environment. Further, because of the importance of data stored within these secret or parameter stores, each of them is typically built in a highly available and redundant manner. For example, the contents of such stores (e.g., key vaults) can be replicated within a first storage located in a first geographic region as well as to a secondary storage located in a second geographic region some distance away. All these qualities are also required for data protection (e.g., backup/restore) solutions. However, the conventional solutions for secret or parameter stores are not able to upload arbitrary documents and/or data files contained within a file system (e.g., computing system) to a secret or parameter store. The current subject matter system may be configured to allow backup/storage of a limited number of data files, such as data files that may be required to restore a state of a particular virtual machine (VM) appliance and/or container instance after an outage or an operational failure.

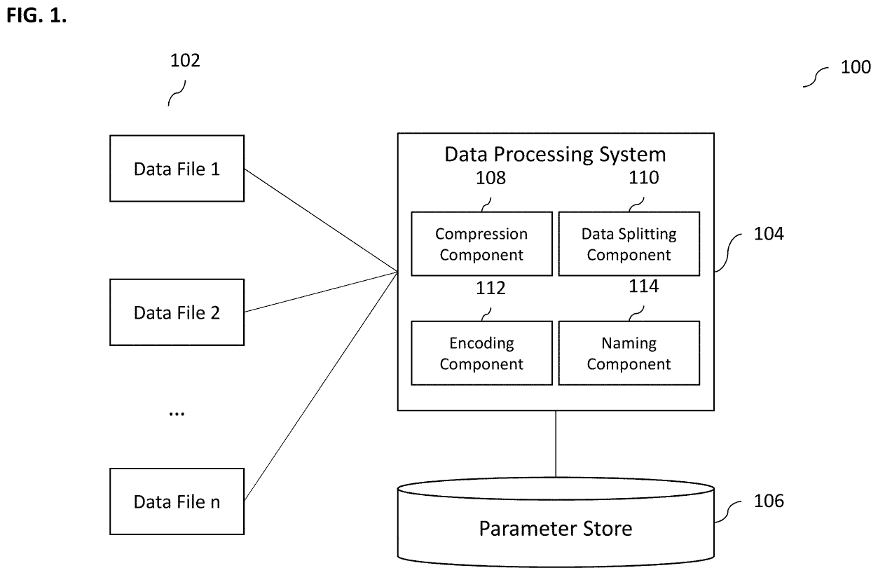

FIG. 1 illustrates an exemplary system 100 for storing one or more data files in one or more parameter stores, according to some implementations of the current subject matter. The system 100 may be configured to operate in one or more database system environments, cloud computing environments, clustered computing environments (e.g., Kubernetes), and/or any other computing environments. It may include one or more locations 102 that may be configured to send one or more data files 102 for backup/restore to (e.g., data file 1, data file 2, . . . , data file n, etc.) a data processing system and/or engine 104, and a parameter store 106. The system 104 may include one or more compression components 108, one or more data splitting components 110, one or more encoding components 112, and one or more naming components 114.

The computing system/engine 104 may include a processor, a memory, and/or any combination of hardware/software, and may be configured to perform processing of data files 102 for storage in the parameter store 106. Components of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The components of the system 100 may include any combination of hardware and/or software. In some implementations, the components may be disposed on one or more computing devices, such as, server(s), database(s), personal computer(s), laptop(s), cellular telephone(s), smartphone(s), tablet computer(s), and/or any other computing devices and/or any combination thereof. In some implementations, the components may be disposed on a single computing device and/or can be part of a single communications network. Alternatively, the components may be separately located from one another.

The parameter store 106 may be used to store various data arranged in one or more tables. The stored data may be modified and/or updated, by way of a non-limiting example, through one or more data manipulation language (DML) processes, which may include one or more operations, including but not limited to, INSERT (e.g., insertion of data into an existing data at a predetermined offset or location), UPDATE (e.g., modification of stored data), and DELETE (e.g., deletion of stored data). Additionally, for example, the stored data may be affected using various data definition language (DDL) statements, which may include creation of various schemas for data storage. In some implementations, the parameter store 106 may include one or more servers, processors, memory locations, cloud computing components/systems, etc. that may be used for accessing data.

The table(s) stored in the parameter store 106 may include at least one column. The database table(s) may store any kind of data. For example, the data may include, but is not limited to, definitions of business scenarios, business processes, and one or more business configurations as well as transactional data, metadata, master data, etc. relating to instances or definitions of the business scenarios, business processes, and one or more business configurations, and/or concrete instances of data objects and/or business objects that are relevant to a specific instance of a business scenario, business process, and/or the like.

In some implementations, the system 100 (and/or any portion thereof) may be implemented as a cloud-based database management system. A cloud-based database management system may be a hardware and/or software system for performing compression, data splitting, encoding, and naming of data files 102 received for backup by the system 104. The parameter store 106 may be a structured, organized collection of data, such as schemas, tables, queries, reports, views, and/or the like, which may be processed for information. Further, the parameter store 106 may be physically stored in a hardware server or across a plurality of hardware servers. A cloud-based database management system may be a hardware and/or software system that interacts with a database, document store, users, and/or other software applications for performing compression, data splitting, encoding, and naming of data files 102 received for backup by the system 104.

In some implementations, the system 104 may be configured to receive one or more data files 102 for backup and storage in the parameter store 106. In response to receiving the data files 102, the system 104 may be configured to perform compression of the data files using compression component 108. The compressed data files may then be split into smaller data chunks using a data splitting component 110, and then encoded using, for example, an ASCII format, using an encoding component 112. The naming component 114 may be configured to assign names to the encoded data files, where the naming of the data files may be performed in accordance with a predetermined format. The data files with assigned names may be stored in the parameter store 106.

In some example, non-limiting, implementations, the parameter store 106 may be configured as a key-value database, where the name of a key may include a series of alpha-numeric characters. An example of a maximum size of a parameter and/or secret value stored in the parameter store 106 may be in a range of 4 kB-64 kB. The value may also include a string-based data. As can be understood, the parameter store 106 may have any other desired storage structure and the stored parameters may have any desired names.

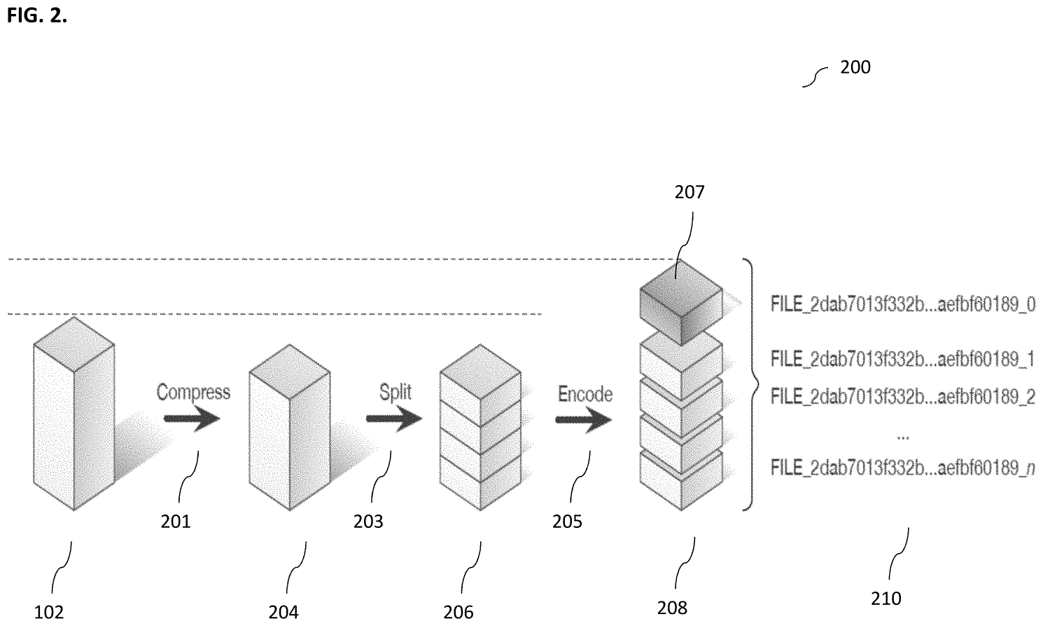

FIG. 2 illustrates an exemplary data file backup system 200, according to some implementations of the current subject matter. The process 200 may be implemented using system 100 shown in FIG. 1 and may be configured to store one or more data files received for backup in the parameter store 106. The process 200 may be configured to be initiated upon receipt of a data file 102 for backup. The system 104 may then be configured to perform a compression operation 201 (e.g., using component 108) to generate a compressed data file 204. The splitting component 110 of the system 104 may be configured to perform a splitting operation 203 to split the compressed data file 204 into multiple smaller data chunks 206.

The smaller data chunks 206 may then be input to the encoding operation 205 (performed by the encoding component 112 shown in FIG. 1) to generated encoded data chunks 208. The encoding may be performed using ASCII format or any other desired format that is supported by the parameter store 106. To ensure data integrity throughout the process 200, a header chunk 207 may be added to the encoded data chunks 208. The header chunk 207 may be configured to include information about other data chunks 208 and/or how data chunks are related to each other.

In some implementations, the data chunks 207, 208 may be configured to be named in accordance with a predetermined naming nomenclature 210. The naming operations may be performed by naming component 114. For example, the name generated and assigned to the data chunk by the naming component 114 may include a base name (e.g., “2dab . . . ”) that may be determined from a hash operation of the data file. The hash operation (which may include any type of hash) may be executed by the naming component 114. It may also have a suffix. The suffix for a header chunk may be defined as “_0” and suffixes for the remaining data chunks may range from “_1” to “_n”, as shown in FIG. 2. In some example, non-limiting implementations, a special prefix (e.g., “FILE_”) may be added to indicate a particular purpose of the respective secret/parameter store entry.

Further, to support one or more backup operations of multiple hosts to the parameter store 106, the naming component 114 may be configured to add a unique host and/or instance name (e.g., <Machine/Instance ID>) during the hash operation for determining the base name of the data chunk. For example, the data chunk may be named as follows:
<Machine/Instance ID>:</file/to/be/backed/up|openss1 dgst-sha256

In some example implementations, the encoding operation 205 may include a binary-to-text encoding (e.g., using a Base64 encoding schema). In that regard, the splitting operation 203 may be adapted accordingly to the available maximum data chunk size.

In some implementations, the header chunk 207 (in addition to ensuring the integrity of the remaining data chunks) may be configured to include a digest (e.g., a SHA256-based digest) as well as data for each data file to be backed up before uploading it. Such data may include at least one of the following: a full data file path, file ownership details (e.g., user/group), file system access permissions (e.g., access mode), a size of the file in bytes, a digest (e.g., SHA256 digest), etc. to ensure the integrity of the file to be protected, a number of required data chunks, and/or any other information.

Using the information included in the header chunk 207, the system 104 may be configured to execute a restore functionality of the processed data file (i.e., chunks 208) stored in the parameter store 106. For example, the system 104 may execute the restore functionality to recreate a 1:1 copy of the original data file that was received for backup (e.g., including the initial owners, file system permissions, etc.). In some exemplary implementations, the header chunk 207 may be further protected (e.g., using a digital signature). Alternatively or in addition to, no further protection may be necessary, as the parameter store 106 may already provide desired protection and/or encryption.

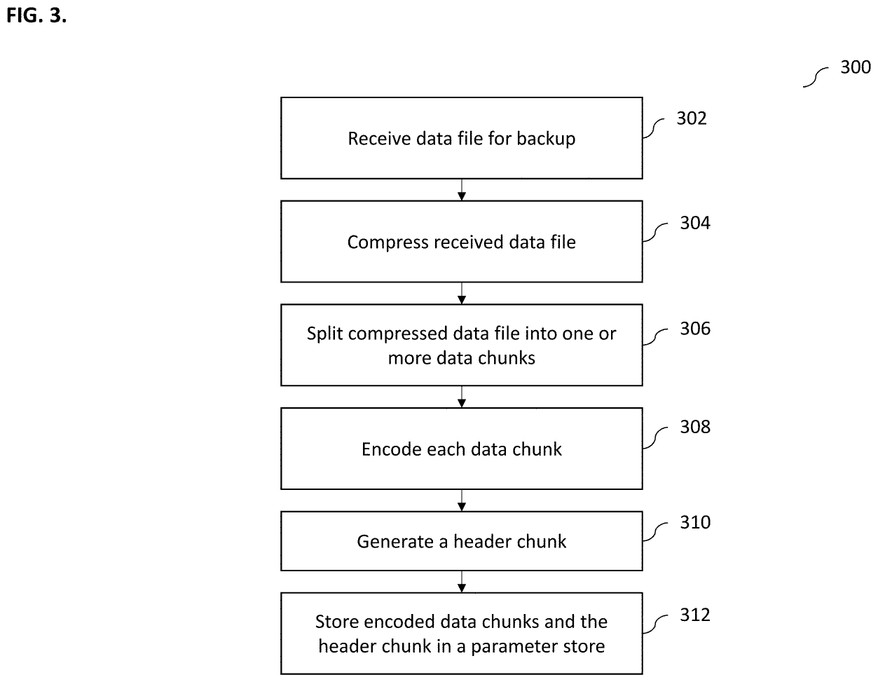

FIG. 3 illustrates an exemplary process 300 for performing a backup of the data file, according to some implementations of the current subject matter. The process 300 may be performed by the system 100 and/or 200 shown in FIGS. 1 and 2, respectively. At 302, a data file (e.g., data file 102) may be received for backup. For example, the system 104 shown in FIG. 1 may be configured to receive the data file 102 for backup.

At 304, the system 104 may be configured to compress the data file 102 into a compressed data file (e.g., compressed data file 204). Any type of compression may be used to reduce the size of the data file.

At 306, the compressed data file may be split into one or more data chunks or portions. The system 104 may use the data splitting component 110 to perform the splitting. The data chunks may be split into the same and/or different sizes. The splitting may be performed based on specifics of the data file and/or data files received for backup. In some example implementations, the actual size of the data chunks may also be determined using the maximum “object size” supported by the parameter store 106. Further, the split size decision may also be a factor in that a subsequent encoding (e.g., Base64 encoding) may lead to a size increase of the encoded chunk.

At 308, encoding of the data chunks may be performed by the system 104. The encoding may involve generation and assignment of a name to each data chunks. The name may identify a specific data chunk, the data file(s) received for backup, the owner of the data file(s), a particular file system from which the data file(s) were received for backup, and/or any other information.

At 310, the system 104 may be configured to generate a header chunk file (e.g., header chunk 207). The header chunk file may be configured to store information about the other data chunks and may be used to identify the group of data chunks that may be associated with one another and/or the header chunk file. The header chunk file may also include a specific name that may or may not include features that may be similar to the names of the other data chunks that are associated with the header chunk file.

At 312, the header chunk and the encoded data files along with the names of each of the encoded data chunks and the header chunk file may be stored in the parameter store 106.

To restore a particular data file, the system 104 may be configured to receive a query identifying the encoded data file. The system 104 may query the parameter store 106 using the identification information received and retrieve the encoded data file by locating it using the header chunk file. Once the encoded data file is received, the process 300 may be performed in reverse, i.e., the encoded data chunks may be decoded, combined together, and decompressed to generate the data file sought by the query.

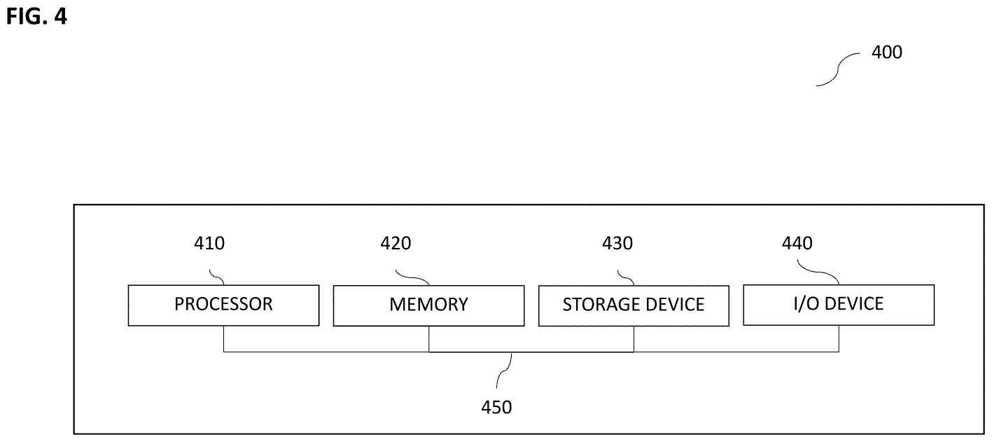

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

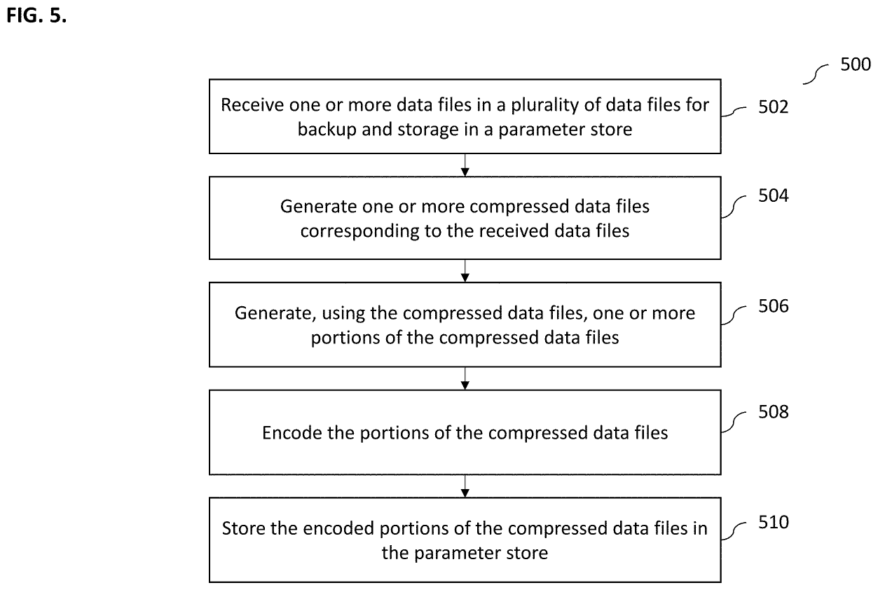

FIG. 5 illustrates an exemplary method 500 for performing backup of a data file in a parameter store, according to some implementations of the current subject matter. The method 500 may be executed by the system 100 (shown in FIG. 1) and/or system 200, as shown in FIG. 2. The method 500 may implement the techniques discussed above in connection with FIGS. 1-3.

At 502, one or more data files (e.g., data files 102 shown in FIG. 1) in a plurality of data files may be received (e.g., by the system 104 shown in FIG. 1) for backup and storage in a parameter store (e.g., parameter store 106). The plurality of data files may be received from one or more file systems.

At 504, one or more compressed data files corresponding to the received data files may be generated. As shown in FIG. 2, the system 104 may be configured to perform compression operation 201 to generate one or more compressed files 204.

At 506, one or more portions of the compressed data files may be generated using the compressed data files. For example, one or more data chunks 206 may be generated using the splitting operation 203, as shown in FIG. 2. The data splitting component 110 of the system 104 may be configured to perform the data splitting operation 506.

At 508, the portions (i.e., data chunks 206) of the compressed data files may be encoded to generate one or more encoded data chunks 208. The encoding may include assigning a predetermined file name (e.g., names 21) to each portion (encoded data chunk 208) of the compressed data files. Each chunk gets an assigned predetermined file name (e.g., a key for a key-value store) that may have at least one common sequence of characters (e.g., “2dab . . . ”) identifying the received data files.

At 510, the encoded portions of the compressed data files may be stored in the parameter store.

In some implementations, the current subject matter may include one or more of the following optional features. The method 500 may also include generating a header file corresponding to the encoded portions of the compressed data files. The header file may include information identifying each of the encoded portions of the compressed data files. The header file may be stored in the parameter store. The method 500 may also include receiving a request to restore from the parameter store the data files corresponding to the encoded portions of the compressed data file, identifying the header file corresponding to the encoded portions of the compressed data file, retrieving, using the identified header file, the encoded portions of the compressed data file from the parameter store, and restoring, using the retrieved encoded portions of the compressed data file, the data file.

In some implementations, the header file may be encoded. Further, each assigned predetermined file name may include a hash of at least a portion of the data file. At least one common sequence of characters in the assigned name may include identification of the file systems associated with the received data files.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving one or more data files in a plurality of data files for backup and storage in a parameter store, the plurality of data files being received from one or more file systems;
generating one or more compressed data files corresponding to the received one or more data files;
generating, using the one or more compressed data files, one or more portions of the compressed data files;
encoding the one or more portions of the compressed data files, the encoding including assigning a predetermined file name to each portion in the one or more portions of the compressed data files, each assigned predetermined file name having at least one common sequence of characters identifying the received one or more data files; and
storing the encoded one or more portions of the compressed data files in the parameter store.

2. The method according to claim 1, further comprising
generating a header file corresponding to the encoded one or more portions of the compressed data files, the header file including information identifying each of the encoded one or more portions of the compressed data files; and
storing the header file in the parameter store.

3. The method according to claim 2, further comprising
receiving a request to restore from the parameter store the one or more data files corresponding to the encoded one or more portions of the compressed data file;
identifying the header file corresponding to the encoded one or more portions of the compressed data file;
retrieving, using the identified header file, the encoded one or more portions of the compressed data file from the parameter store; and
restoring, using the retrieved encoded one or more portions of the compressed data file, the data file.

4. The method according to claim 2, wherein the header file is encoded.

5. The method according to claim 1, wherein each assigned predetermined file name includes a hash of at least a portion of the data file.

6. The method according to claim 1, wherein at least one common sequence of characters includes identification of the one or more file systems associated with the received one or more data files.

7. A system comprising:
at least one programmable processor; and
a non-transitory machine-readable medium storing instructions that, when executed by the at least one programmable processor, cause the at least one programmable processor to perform operations comprising:
receiving one or more data files in a plurality of data files for backup and storage in a parameter store, the plurality of data files being received from one or more file systems;
generating one or more compressed data files corresponding to the received one or more data files;
generating, using the one or more compressed data files, one or more portions of the compressed data files;
encoding the one or more portions of the compressed data files, the encoding including assigning a predetermined file name to each portion in the one or more portions of the compressed data files, each assigned predetermined file name having at least one common sequence of characters identifying the received one or more data files; and
storing the encoded one or more portions of the compressed data files in the parameter store.

8. The system according to claim 7, wherein the operations further comprise
generating a header file corresponding to the encoded one or more portions of the compressed data files, the header file including information identifying each of the encoded one or more portions of the compressed data files; and
storing the header file in the parameter store.

9. The system according to claim 8, wherein the operations further comprise
receiving a request to restore from the parameter store the one or more data files corresponding to the encoded one or more portions of the compressed data file;
identifying the header file corresponding to the encoded one or more portions of the compressed data file;
retrieving, using the identified header file, the encoded one or more portions of the compressed data file from the parameter store; and
restoring, using the retrieved encoded one or more portions of the compressed data file, the data file.

10. The system according to claim 8, wherein the header file is encoded.

11. The system according to claim 7, wherein each assigned predetermined file name includes a hash of at least a portion of the data file.

12. The system according to claim 7, wherein at least one common sequence of characters includes identification of the one or more file systems associated with the received one or more data files.

13. A computer program product comprising a non-transitory machine-readable medium storing instructions that, when executed by at least one programmable processor, cause the at least one programmable processor to perform operations comprising:
receiving one or more data files in a plurality of data files for backup and storage in a parameter store, the plurality of data files being received from one or more file systems;
generating one or more compressed data files corresponding to the received one or more data files;
generating, using the one or more compressed data files, one or more portions of the compressed data files;
encoding the one or more portions of the compressed data files, the encoding including assigning a predetermined file name to each portion in the one or more portions of the compressed data files, each assigned predetermined file name having at least one common sequence of characters identifying the received one or more data files; and
storing the encoded one or more portions of the compressed data files in the parameter store.

14. The computer program product according to claim 13, wherein the operations further comprise
generating a header file corresponding to the encoded one or more portions of the compressed data files, the header file including information identifying each of the encoded one or more portions of the compressed data files; and
storing the header file in the parameter store.

15. The computer program product according to claim 14, wherein the operations further comprise
receiving a request to restore from the parameter store the one or more data files corresponding to the encoded one or more portions of the compressed data file;
identifying the header file corresponding to the encoded one or more portions of the compressed data file;
retrieving, using the identified header file, the encoded one or more portions of the compressed data file from the parameter store; and
restoring, using the retrieved encoded one or more portions of the compressed data file, the data file.

16. The computer program product according to claim 14, wherein the header file is encoded.

17. The computer program product according to claim 13, wherein each assigned predetermined file name includes a hash of at least a portion of the data file.

18. The computer program product according to claim 13, wherein at least one common sequence of characters includes identification of the one or more file systems associated with the received one or more data files.
